(19) United States
(12) Patent Application Publication
(10) Pub. No.: US 2018/0063137 A1
(43) Pub. Date: Mar. 1, 2018

(54) INFORMATION PROCESSING APPARATUS, INFORMATION PROCESSING METHOD, AND NON-TRANSITORY COMPUTER READABLE MEDIUM

(71) Applicant: FUJI XEROX CO., LTD., Tokyo (JP)

(72) Inventor: Masayoshi KISHIDA, Kanagawa (JP)

(73) Assignee: FUJI XEROX CO., LTD., Tokyo (JP)

(21) Appl. No.: 15/492,350

(22) Filed: Apr. 20, 2017

(30) Foreign Application Priority Data
Aug. 23, 2016 (JP) 2016-162753

(51) Int. Cl. H04L 29/06

(52) U.S. Cl. CPC H04L 63/0884; H04L 63/0281; H04L 63/083

(57) ABSTRACT

An information processing apparatus includes:
a process identification information acquiring unit that acquires process identification information in response to a request for execution of a process designated by a process identification code from a delegatee who is to execute the process by proxy through delegation and who has no authority to execute the process, wherein
the process identification information at least including
   (i) identification information of a delegator which is set corresponding to the process identification code, the delegator who allows the process to be executed by proxy through the delegation, and
   (ii) an authority given to the delegatee by the delegator on the execution of the process; and
a controller that controls the execution of the process in response to the request for the execution from the delegatee according to the authority included in the process identification information acquired by the process identification information acquiring unit.

### CROSS-REFERENCE TO RELATED APPLICATIONS

This application is based on and claims priority under 35 USC 119 from Japanese Patent Application No. 2016-162753 filed Aug. 23, 2016.

### BACKGROUND

### (i) Technical Field

The present invention relates to an information processing apparatus, an information processing method, and a non-transitory computer readable medium.

### (ii) Related Art

There has been a flow management system that sequentially processes an input, processing, a distribution, and the like based on information of an instruction sheet in which a process flow is defined. In the flow management system, a process involving an authentication is also performed for security. When a user requests the flow management system to execute the process involving an authentication, the user may input and designate his/her authentication information if he/she has an authority or the like necessary for authentication.

Meanwhile, in some cases, a user may want to delegate a process involving an authentication to another user such that the other user acts on behalf of the user, for some reason. In this case, when the delegated user (delegatee) who is to act by proxy according to the delegation does not have an authority to execute the process, he/she cannot execute the process.

### SUMMARY

According to an aspect of the invention, an information processing apparatus includes:

a process identification information acquiring unit that acquires process identification information in response to a request for execution of a process designated by a process identification code from a delegatee who is to execute the process by proxy through delegation and who has no authority to execute the process, wherein

the process identification information at least including
(i) identification information of a delegator which is set corresponding to the process identification code, the delegator who allows the process to be executed by proxy through the delegation, and
(ii) an authority given to the delegatee by the delegator on the execution of the process; and

a controller that controls the execution of the process in response to the request for the execution from the delegatee according to the authority included in the process identification information acquired by the process identification information acquiring unit.

### BRIEF DESCRIPTION OF THE DRAWINGS

Exemplary embodiments of the present invention will be described in detail based on the following figures, wherein:

FIG. 1 is an overall configuration diagram of a system including a flow management system in an exemplary embodiment;

FIG. 2 is a block configuration diagram of the flow management system in the exemplary embodiment;

FIG. 3 is a hardware configuration diagram of each server computer included in the flow management system in the exemplary embodiment;

FIG. 4 is a view illustrating an example of a data structure of usage authority information set in advance in a usage authority information memory in the exemplary embodiment;

FIG. 5 is a view illustrating an example of a data structure of authentication information set in advance in an authentication information memory in the exemplary embodiment;

FIG. 6 is a flow chart illustrating a process of generating an access key in the exemplary embodiment;

FIG. 7 is a view illustrating an example of a data structure of access key information stored in an access key information memory in the exemplary embodiment;

FIG. 8 is a view illustrating a data setting example of a scan policy stored in a scan policy memory in the exemplary embodiment;

FIG. 9 is a flowchart illustrating a scan proxy process in the exemplary embodiment; and

FIG. 10 is a view illustrating a display example of a delegation scan screen in the exemplary embodiment.

### DETAILED DESCRIPTION

Hereinafter, an exemplary embodiment of the present invention will be described with reference to drawings.

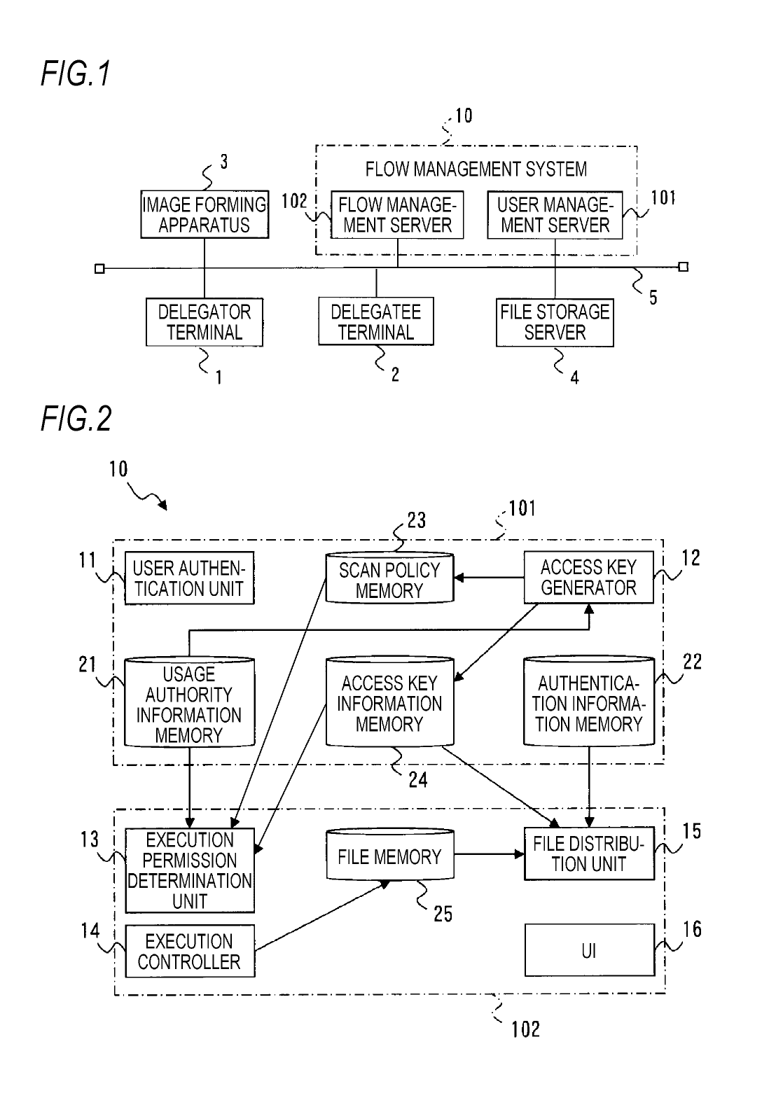

FIG. 1 is an overall configuration diagram of a system including a flow management system 10 in the exemplary embodiment. FIG. 1 illustrates a configuration in which the flow management system 10, a delegator terminal 1, a delegatee terminal 2, an image forming apparatus 3, and a file storage server 4 are connected to a LAN 5. The flow management system 10 in the exemplary embodiment corresponds to an information processing apparatus according to the present invention, and includes a user management server 101 configured to manage users of the system and a flow management server 102 configured to manage a process flow to be executed in response to a request from a user, and control the execution of the process flow. In the exemplary embodiment, the flow management system 10 is constructed such that functions of user management and flow management are distributed to the user management server 101 and the flow management server 102. Alternatively, the functions may be integrated into one server computer, or may be distributed to three or more server computers.

Each of the delegator terminal 1 and the delegatee terminal 2 is an information terminal device used by the user of the flow management system 10, and is implemented with, for example, a general-purpose hardware configuration such as a personal computer (PC). Among them, the delegator terminal 1 is used by a delegator who delegates a process to a delegatee. The delegatee terminal 2 is used by the delegatee who executes the process by proxy according to delegation.

The image forming apparatus 3 is a multifunction device having plural functions such as a scan function, a print function and the like, and an apparatus in which a computer including a CPU, a ROM, a RAM, a HDD and the like is incorporated. In the exemplary embodiment, an operation will described, using a process by way of an example in which a document image data file generated by scanning a document by the image forming apparatus 3 (hereinafter, simply referred to as a “file”) is sent to a distribution destination and stored. The file storage server 4 is a server computer that becomes a candidate for a storage location of the file.

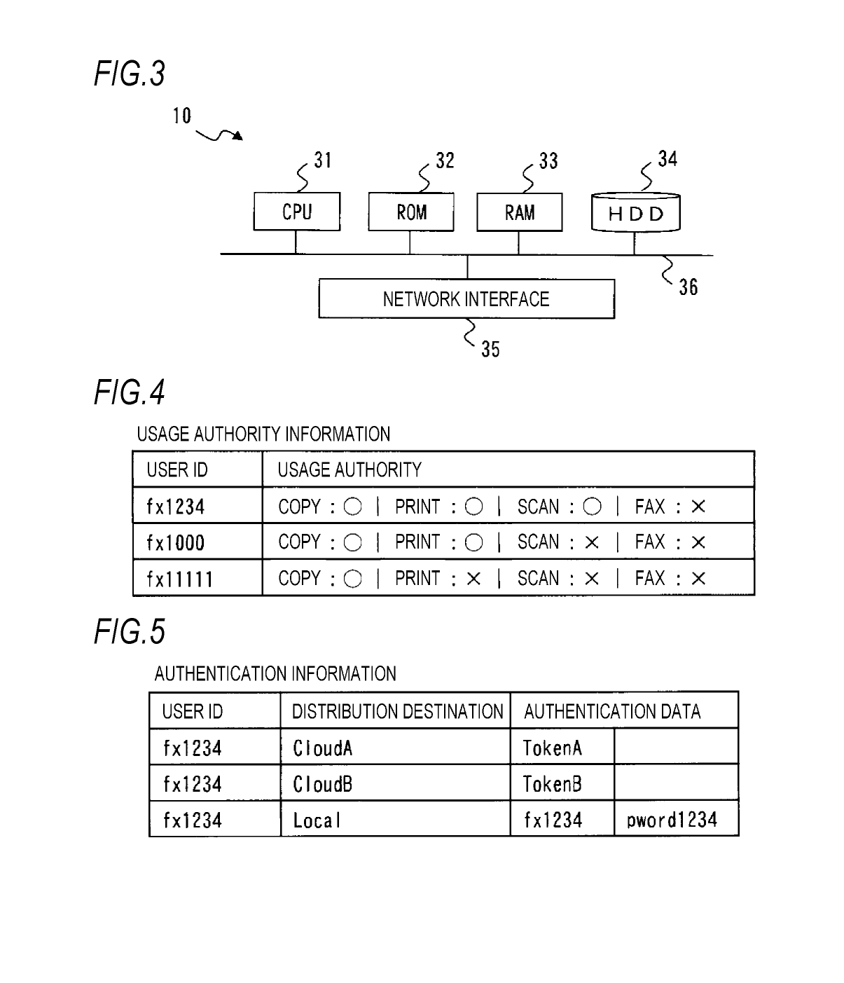

FIG. 2 is a block configuration diagram of the flow management system 10 in the exemplary embodiment. FIG. 3 is a hardware configuration diagram of the server computers 101 and 102 included in the flow management system 10 in the exemplary embodiment. Each of the server computers 101 and 102 in the exemplary embodiment is implemented with a hardware configuration of a general-purpose server computer existing from the past. That is, each of the server computers 101 and 102 has a configuration in which a CPU 31, a ROM 32, a RAM 33, a hard disk drive (HDD) 34, and a network interface 35 provided as a communication unit are connected to an internal bus 36 as illustrated in FIG. 3. As necessary, in the configuration, a user interface such as a mouse, a keyboard, a display or the like may be connected.

Referring back to FIG. 2, the flow management system 10 includes a user authentication unit 11, an access key generator 12, an execution permission determination unit 13, an execution controller 14, a file distribution unit 15, a user interface (UI) 16, a usage authority information memory 21, an authentication information memory 22, a scan policy memory 23, an access key information memory 24, and a file memory 25. FIG. 2 illustrates a state where respective configuration components are distributed to the user management server 101 or the flow management server 102, while in the following description, the configuration components are described as configuration components included in the flow management system 10. The configuration components not used for the description of the exemplary embodiment are omitted in FIG. 2.

The user authentication unit 11 authenticates a user who intends to log in to the image forming apparatus 3. The access key generator 12 is provided as a generating unit to newly issue a process identification code (access key) in response to a request by a delegator and generate access key information in which information pieces designated by the delegator are associated with each other. The execution permission determination unit 13 determines whether or not it is permitted to execute the process in response to a request for execution of the process from a delegatee. The execution controller 14 is provided as a controller to control the execution of the process in response to the request for the execution of the process from the delegatee in accordance with the authority included in the access key information corresponding to an access key designated by the delegatee. The file distribution unit 15 distributes a file generated by scanning to a designated distribution destination under the control by the execution controller 14. The user interface 16 sends a web page to the image forming apparatus 3 so as to control information display on an operation panel of the image forming apparatus 3, and acquire information input from the operation panel.

FIG. 4 is a view illustrating an example of a data structure of usage authority information set in advance in the usage authority information memory 21 in the exemplary embodiment. In the exemplary embodiment, in order to describe, for example, the storage of a document scanned by the image forming apparatus 3, a setting example of usage authority information on the image forming apparatus 3 is illustrated. In the usage authority information, it is set whether each user identified by a user ID is permitted to use each of functions provided by the image forming apparatus 3, such as copy, print, scan and facsimile functions. In FIG. 4, “◯” indicates that the function is available, and “x” indicates that the function is unavailable.

FIG. 5 is a view illustrating an example of a data structure of authentication information set in advance in the authentication information memory 22 in the exemplary embodiment. In the authentication information, a distribution destination and authentication data are set in association with a user ID of a user to be authenticated. A distribution destination of a file is set for the distribution destination. According to the setting example of FIG. 5, respective pieces of authentication data are set in the file storage server 4 indicated by clouds “CloudA” and “CloudB,” and “Local” which are set as distribution destinations of a file of a user with a user ID “fx1234.”

Other memories 23 to 25 will be described in conjunction with the explanation of the operation because information stored in the operation process is generated and registered in the memories 23 to 25.

The configuration components 11 to 15 in the flow management system 10 are implemented with a cooperation of a computer forming the flow management system 10, and a program operating in the CPU 31 mounted in the computer. The memories 21 to 25 are implemented with the HDD 34 mounted in the flow management system 10. Alternatively, the RAM 33 or an external memory may be used via a network.

The program used in the exemplary embodiment may be provided not only by a communication unit, but also by a computer readable recording medium such as a CD-ROM or a USB memory in which the program is stored. The program provided from a communication unit or a recording medium is installed in the computer, and the CPU of the computer sequentially executes the program, thereby implementing various processes.

Due to security concerns, there are processes which require a certain authentication or authority when the processes are executed. Meanwhile, in the following description, unless otherwise stated, a process requiring an authentication or authority for execution is also simply referred to as a “process.” In some cases, a person may want another person (delegatee) to execute the process on behalf of him/herself, for some reason. As a typical example, there is a case where a president (delegator) delegates a secretary (delegatee) to execute the process on behalf of him/herself. In general, various authorities are given to the president, but the secretary is not granted the same authorities as the president. If the delegatee does not have an authority to execute the process, he/she cannot execute the process. If the delegator tells the delegatee his/her authentication information, the process may be carried out. However, this is not desirable for security.

Therefore, in the exemplary embodiment, an access key (which will be described below) is utilized so that even a delegatee who has no authority is permitted to execute the process.

Hereinafter, an operation in the exemplary embodiment will be described. In the exemplary embodiment, descriptions will made on, by way of an example, a case where a person (delegator) having a process authority designates a user (delegatee) whom he wants to execute the process by proxy and delegates the execution of the process. Hereinafter, descriptions will be made on, by way of an example, a process in which a file generated by scanning a document is stored in a designated distribution destination. Here, the delegatee has no authority to execute the process.

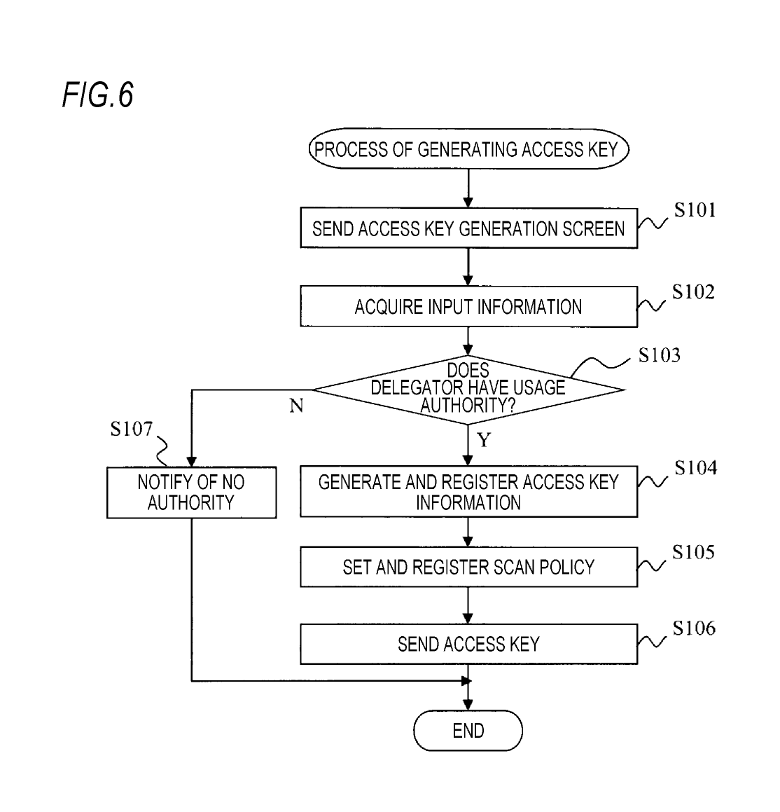

First, a process of generating a characteristic access key in the exemplary embodiment will be described using the flow chart illustrated in FIG. 6.

A delegator logs in to the flow management system 10, and performs a predetermined operation to request generation of an access key. The access key generator 12 sends a predetermined access key generation screen (web page) to the delegator terminal 1 in response to the generation request from the delegator, to thereby display the screen. The delegator inputs and designates information required for generating the access key on the displayed screen. Specifically, the delegator inputs and designates a process delegatee, file storage location information, a distribution destination and a scan policy.

When acquiring information input by the delegator (step S102), the access key generator 12 recognizes that a scan function is to be used according to the contents input by the delegator or an explicit instruction made by the delegator. Then, the access key generator 12 refers to usage authority information, thereby verifying whether the delegator has an authority to use the scan function. When the delegator has no usage authority (N in step S103), the access key generator 12 sends a message indicating that the delegator has no usage authority to the delegator terminal 1, thereby notifying that an access key cannot be generated (step S107). Meanwhile, when the delegator has a usage authority (Y in step S103), the access key generator 12 newly issues an access key based on the acquired information, generates access key information and registers the access key information in the access key information memory 24 (step S104). A scan policy is set based on the policy set by the delegator and is registered in the scan policy memory 23 (step S105).

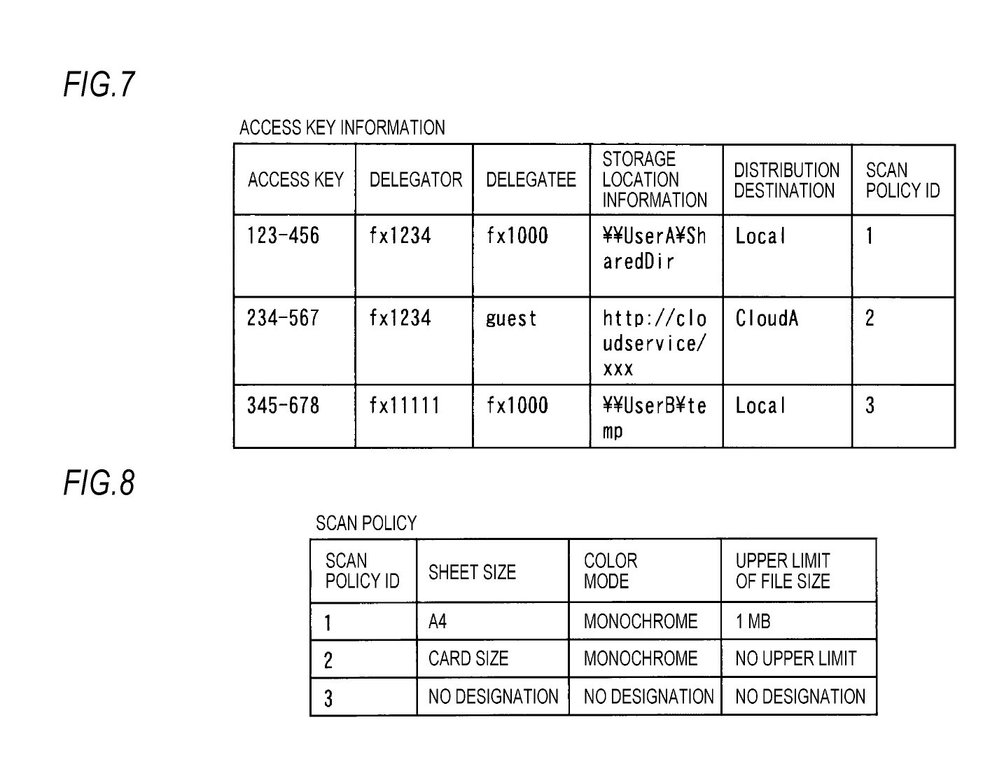

FIG. 7 is a view illustrating an example of a data structure of access key information stored in the access key information memory 24 in the exemplary embodiment. In the access key information, identification information (user ID) of a log-in user (delegator), identification information (user ID) of a delegatee, file storage location information, file distribution destination, and a scan policy ID are set in association with a unique access key newly issued in response to the generation request.

In the exemplary embodiment, as information on a file distribution destination, a set of storage location information and a distribution destination is set. FIG. 7 illustrates an example where only one set of information is set for information of each access key, but plural sets may be set. That is, through one scanning, distributions to plural destinations may be made.

Information on the distribution destination is not limited to the setting example illustrated in FIG. 7. As the distribution destination, not only a shared folder of a PC, or a repository of an external cloud service, but also a FAX number or a mail address may be set.

FIG. 8 is a view illustrating a data setting example of a scan policy stored in the scan policy memory 23 in the exemplary embodiment. In the scan policy, an authority or a condition in using a scan function is defined according to the contents set by the delegator. The scan policy is granted a scan policy ID, and the scan policy ID granted to the scan policy is set in access key information so that an access key is associated with the scan policy.

When setting and registering the access key information and the scan policy as described above, the access key generator 12 sends the access key to the delegator terminal 1 as a request source (step S106).

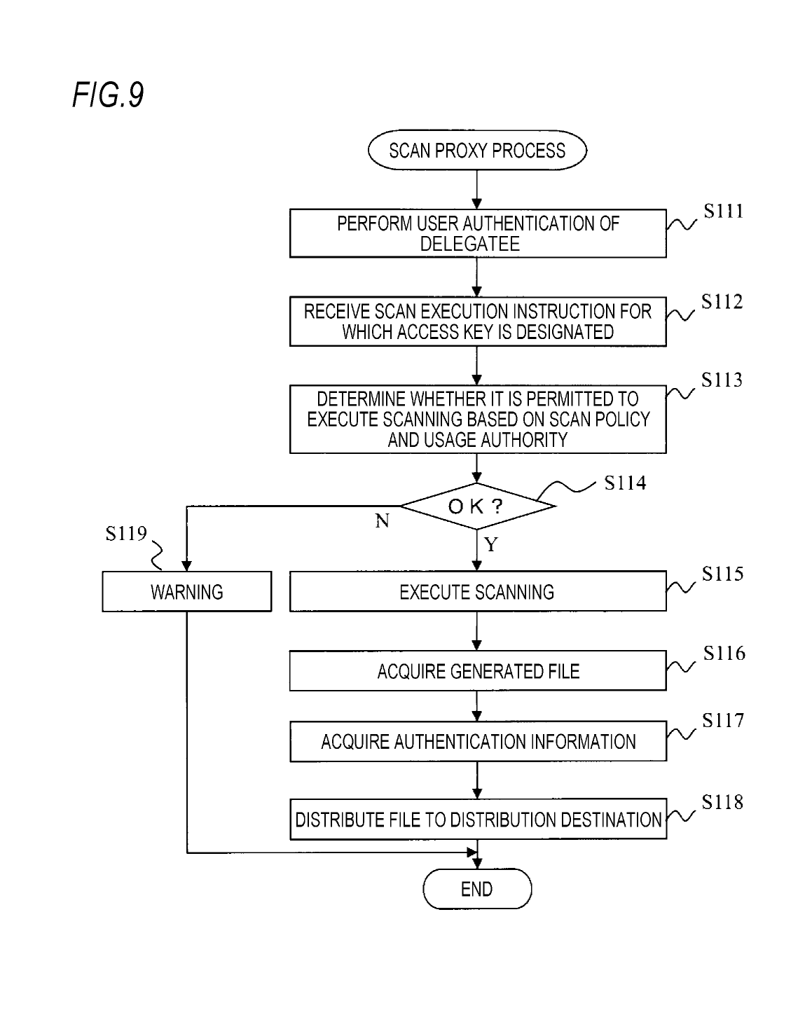

Thereafter, the delegator notifies a delegatee of the notified access key, and thus makes the delegatee execute the process by proxy. In this case, the access key may be notified via e-mail or verbally. Alternatively, the flow management system 10 may inform the delegatee of the access key according to a request or the like from the delegator. Hereinafter, descriptions will be made on a scan proxy process which is executed when a delegatee is to execute the process by proxy, using a flow chart illustrated in FIG. 9.

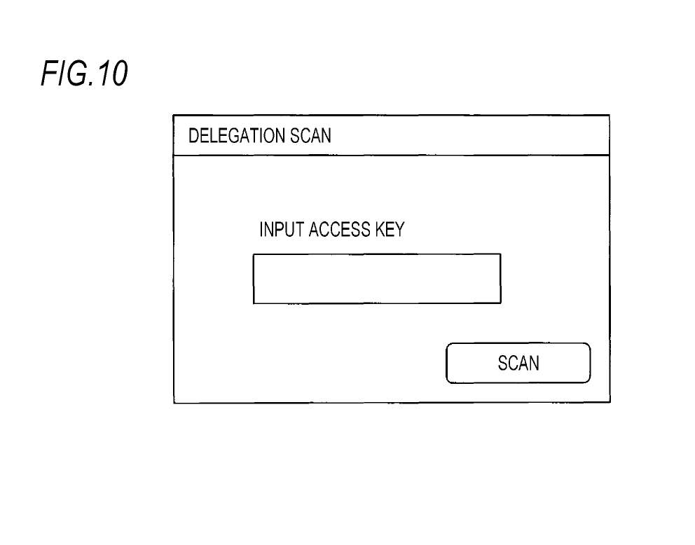

The delegatee moves to the image forming apparatus 3 with a document to be distributed in order to perform delegated scanning, and logs in to the image forming apparatus 3. The delegatee authentication data input to the image forming apparatus 3 at the time of log-in is sent to the flow management system 10, and the user authentication unit 11 performs user authentication (step S111). After successful log-in, when the delegatee performs a predetermined scan start operation for scanning, the user interface 16 sends a delegation scan screen (web page) to the image forming apparatus 3 according to the operation, thereby displaying the screen on the operation panel. A display example of the delegation scan screen is illustrated in FIG. 10. The delegation scan screen is a screen different from a normal scan execution screen, and requests the delegatee to enter an access key. A graphical user interface (GUI) component for displaying the delegation scan screen may be displayed on a menu screen or the like and selected by the delegatee so that the delegation scan screen may be displayed. Alternatively, when the delegatee selects a scan button in a usual manner, and a user ID of a user who has made an operation is set as the delegatee of access key information, the delegation scan screen may be automatically selected and sent to the image forming apparatus 3. Alternatively, when a user ID of a logged-in user at the time of log-in is set as the delegatee of the access key information, the delegation scan screen may be automatically selected and sent to the image forming apparatus 3.

When the delegatee inputs an access key on the delegation scan screen, and selects a scan button to instruct execution of scan, the execution permission determination unit 13 receives a scan execution instruction for which the access key has been input and designated through the image forming apparatus 3 (step S112). Thereafter, the execution permission determination unit 13 reads the access key information corresponding to the designated access key from the access key information memory 24, and determines whether it is permitted to execute scanning according to the scan execution instruction (step S113). Specifically, it is determined whether a user ID of the delegatee set corresponding to the access key matches a user ID of a user who has logged in to the image forming apparatus 3, and it is determined whether scan settings violate a scan policy corresponding to a scan policy ID set corresponding to the access key. When it is determined that the user is a valid delegatee and that the settings do not violate the scan policy (Y in step S114), the execution permission determination unit 13 notifies the execution controller 14 that it is permitted to execute scanning. The execution controller 14 instructs the image forming apparatus 3 to execute scanning according to the notification so that the scanning is executed (step S115). The execution controller 14 acquires a file generated by the scanning and stores the file in the file memory 25 (step S116).

Meanwhile, when the execution permission determination unit 13 determines that it is not permitted to execute scanning (N in step S114), the execution permission determination unit notifies the execution controller 14 that it is not permitted to execute scanning. The execution controller 14 displays a warning message including a reason for the disapproval on the operation panel, according to the notification, and stops the execution of scanning (step S119).

When the file is acquired, the file distribution unit 15 acquires the delegator, storage location information, and a distribution destination corresponding to the access key from the access key information memory 24. Then, the file distribution unit 15 acquires authentication information corresponding to the distribution destination of the delegator from the authentication information memory 22 (step S117). Subsequently, the file distribution unit 15 receives authentication of the distribution destination using the authentication information, and distributes the file to the distribution destination such that the file is stored in a storage location specified by the storage location information (step S118).

According to the exemplary embodiment, even a delegatee who has no authority to execute the process can execute the process according to an authority granted by a delegator. Particularly, it is permitted to execute the process without other settings so long as an access key is input. In the case of a process involving distribution as in the exemplary embodiment, the delegatee may automatically perform distribution without setting a distribution destination or the like. That is, since the delegator does not need to make the delegatee set the distribution destination or the like, it is possible to prevent erroneous distribution due to setting mistakes by the delegatee or distribution by fraud. The delegatee may be proved to be a valid delegatee by only inputting an access key notified from the delegator.

At a point of time when a process is to be executed by the delegatee by proxy (step S112) or when it is verified that it is permitted to execute the process by the delegatee (Y in step S114), the delegator may be notified that the process is to be executed. Only after an approval for the execution is given by the delegator, the process may start to be executed.

The access key is generated to be notified to the delegatee. Alternatively, the delegator him/herself may execute the process using the access key. When the access key is allowed to be used plural times, it is not necessary to set a distribution destination or the like each time the process is executed.

In the exemplary embodiment, descriptions have been made using an example where the present invention is applied to a process in which a document scanned by the image forming apparatus 3 is sent to a designated distribution destination and stored. It should be noted that the invention is not limited to the exemplary embodiment. Alternatively, the invention may be applied to other functions such as copy and print functions. Also, it is not necessary to limit the process to processes using functions provided by the image forming apparatus 3.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
a process identification information acquiring unit that acquires process identification information in response to a request for execution of a process designated by a process identification code from a delegatee who is to execute the process by proxy through delegation and who has no authority to execute the process, wherein
the process identification information at least including
(i) identification information of a delegator which is set corresponding to the process identification code, the delegator who allows the process to be executed by proxy through the delegation, and
(ii) an authority given to the delegatee by the delegator on the execution of the process; and
a controller that controls the execution of the process in response to the request for the execution from the delegatee according to the authority included in the process identification information acquired by the process identification information acquiring unit.

2. The information processing apparatus according to claim 1, wherein
the process identification information includes identification information of the delegatee designated by the delegator, and
if identification information of the delegatee who has made the request for the execution matches the identification information of the delegatee included in the process identification information, the controller causes the process to be executed.

3. The information processing apparatus according to claim 1, further comprising:
an authentication information acquiring unit that acquires authentication information required for the delegator to execute the process, wherein
the controller causes the process to be executed using the authentication information acquired by the authentication information acquiring unit in response to the request for the execution from the delegatee.

4. The information processing apparatus according to claim 1, wherein
the process identification information includes information that specifies a distribution destination of a file designated by the delegator, and
the controller causes the file to be distributed to the distribution destination specified by the process identification information in response to the request for the execution involving file distribution from the delegatee.

5. The information processing apparatus according to claim 1, wherein if the delegatee attempts to execute the process in violation of the authority included in the process identification information acquired by the process identification information acquiring unit, the controller stops the execution of the process and issues a warning to the delegatee.

6. The information processing apparatus according to claim 1, further comprising:
a generator that generates the process identification information including a process identification code newly issued in response to a request from the delegator.

7. The information processing apparatus according to claim 2, further comprising:
a generator that generates the process identification information including a process identification code newly issued in response to a request from the delegator.

8. The information processing apparatus according to claim 3, further comprising:
a generator that generates the process identification information including a process identification code newly issued in response to a request from the delegator.

9. The information processing apparatus according to claim 4, further comprising:
a generator that generates the process identification information including a process identification code newly issued in response to a request from the delegator.

10. An information processing method comprising:
acquiring process identification information in response to a request for execution of a process designated by a process identification code from a delegatee who is to execute the process by proxy through delegation and who has no authority to execute the process, wherein
the process identification information at least including
(i) identification information of a delegator which is set corresponding to the process identification code, the delegator who allows the process to be executed by proxy through the delegation, and
(ii) an authority given to the delegatee by the delegator on the execution of the process; and
controlling the execution of the process in response to the request for the execution from the delegatee according to the authority included in the acquired process identification information.

11. A non-transitory computer readable medium storing a program causing a computer to execute information processing comprising:
acquiring process identification information in response to a request for execution of a process designated by a process identification code from a delegatee who is to execute the process by proxy through delegation and who has no authority to execute the process, wherein
the process identification information at least including
(i) identification information of a delegator which is set corresponding to the process identification code, the delegator who allows the process to be executed by proxy through the delegation, and
(ii) an authority given to the delegatee by the delegator on the execution of the process; and
controlling the execution of the process in response to the request for the execution from the delegatee according to the authority included in the acquired process identification information.
